(19) United States
(12) Patent Application Publication
(10) Pub. No.: US 2004/0264356 A1
(43) Pub. Date: Dec. 30, 2004

(54) Holographic data storage medium

(76) Inventors: Hon-Lun Chen, Taipei (TW); Kuo-Hsin Teng, Taipei (TW)

Correspondence Address: BIRCH STEWART KOLASCH & BIRCH, PO BOX 747, FALLS CHURCH, VA, 22040-0747, US

(21) Appl. No.: 10/732,469

(22) Filed: Dec. 11, 2003

(30) Foreign Application Priority Data
Jun. 30, 2003 (TW) 092117860

(51) Int. Cl. G11B 7/24

(52) U.S. Cl. 369/275.2; 369/103

(57) ABSTRACT

A holographic data storage medium includes a data storage body and a protective layer such as an anti-UV protective layer. The data storage body is used to record a holographic data such as a hologram or a holographic image. The protective layer is formed on the surface of the data storage body. In this case, only light of specific wavelength excepting UV light is allowed to pass through the protective layer, so that the data storage body can be prevented from UV light.

### BACKGROUND OF THE INVENTION

1. Field of Invention

The invention relates to a data storage medium and, in particular, to a holographic data storage medium for recording three-dimensional image data.

2. Related Art

Accompanying the progress of technology, an optical recording medium is one of the most popular ways for data storage. The typical optical recording medium, for example, includes the compact disc (CD) and digital versatile disc (DVD). The trends of the present industries, such as the video images with high resolution provided by the digitized mass media, the widespread family digital center and the development of virtual reality games, have resulted in the inadequacy of the above-mentioned optical recording medium.

To solve the previously mentioned problem, the holographic data storage medium is one of the best choices. Comparing with the other optical recording medium, the holographic data storage medium possesses larger capacity for data storage and better data transferring rate. The main difference between the holographic data storage medium and the current optical data storage is the use of photosensitive polymeric material and the interference between two light intensities. A reference beam is passed through a phase mask, and intersected in the holographic data storage medium with a signal beam. The interference of the two light beams causes the writing of three-dimensional image data onto the holographic data storage medium. The three-dimensional image data is known as the holographic data, and the capacity of the storage medium is enlarged accordingly.

Referring to FIG. 1, a laser beam 2 from a coherent laser source is split into two beams, a signal beam 20 (data-carrying) and a reference beam 22. Digital data to be stored are encoded onto the signal beam 20 via a modulating device 12. The data or strings of bits are first arranged into pages or large arrays. The 0's and 1's of the data pages are translated into light and dark pixels of the modulating device 12. In this manner, the signal beam 20 is encoded with a data image. The image is stored by interfering the encoded signal beam 20 with the reference beam 22 at a location on or within a holographic data storage medium 14. The interference creates an interference pattern (or hologram) that is captured within the holographic data storage medium 14 as a pattern of, for example, varying refractive index. It is possible for more than one holographic image to be stored at a single location, or for holograms to be stored in overlapping positions, by, for example, varying the angle, the wavelength, or the phase of the reference beam 22, depending on the particular reference beam 22 employed. The signal beam 20 typically passes through a first lens 30 before being intersected with the reference beam 22 in the holographic data storage medium 14. It is possible for the reference beam 22 to pass through a second lens 32 before this intersection.

With reference to FIG. 2, once data is stored in the holographic data storage medium 14, it is possible to retrieve the data by intersecting the reference beam 22 with the holographic data storage medium 14 at the same location and at the same angle, wavelength, or phase at which the reference beam 22 was directed during storage of the data. The reconstructed data passes through a third lens 34 and is detected by a sensor 16 that reads the data in parallel. The sensor 16 is, for example, a charged coupled device or an active pixel sensor. The parallel readout of data provides holography with its fast data transfer rates.

However, due to the holographic data storage medium is consisting of photosensitive materials, the data stored onto the holographic data storage medium would be lost or cross-talk if exposed to UV light for a period of time.

Therefore, it is an important subjective to protect the photosensitive material of the holographic data storage medium and the data stored therein from being damaged by UV light.

### SUMMARY OF THE INVENTION

In view of the foregoing subjective, the invention is directed to a holographic data storage medium, which can protect the photosensitive material therein from UV light.

Additional features and advantages of the invention will be set forth in part in the description which follows, and in part will be obvious from the description, or may be learned by practice of the invention. The objectives and other advantages of the invention will be realized and attained by that particularly pointed out in the written description and claims hereof as well as the appended drawings. To achieve these and other advantages and in accordance with the purpose of the invention, as embodied and broadly described herein, the invention is directed to a holographic data storage medium, including a data storage body and a protective layer. In the invention, the data storage body is used to record a holographic data and is made of a photosensitive material. The protective layer is an anti-UV protective layer and is formed on the surface of the data storage body. Only light of specific wavelength is allowed to pass through the protective layer, so that the data storage body can be prevented from being irradiated by UV light.

Since the holographic data storage medium of the invention includes a protective layer for filtering UV light, the photosensitive material thereof can be protected. Thus, the data recorded in the data storage body would not be damaged by the UV light.

### BRIEF DESCRIPTION OF THE DRAWINGS

The invention will become more fully understood from the detailed description given herein below illustrations only, and thus is not limitative of the present invention, and wherein:

FIG. 1 is a schematic view showing a basic holographic storage system, which writes data into a conventional holographic data storage medium;

FIG. 2 is a schematic view showing a basic holographic storage system, which retrieves data from the conventional holographic data storage medium; and

FIG. 3 is a schematic view showing a holographic data storage medium according to a preferred embodiment of the invention.

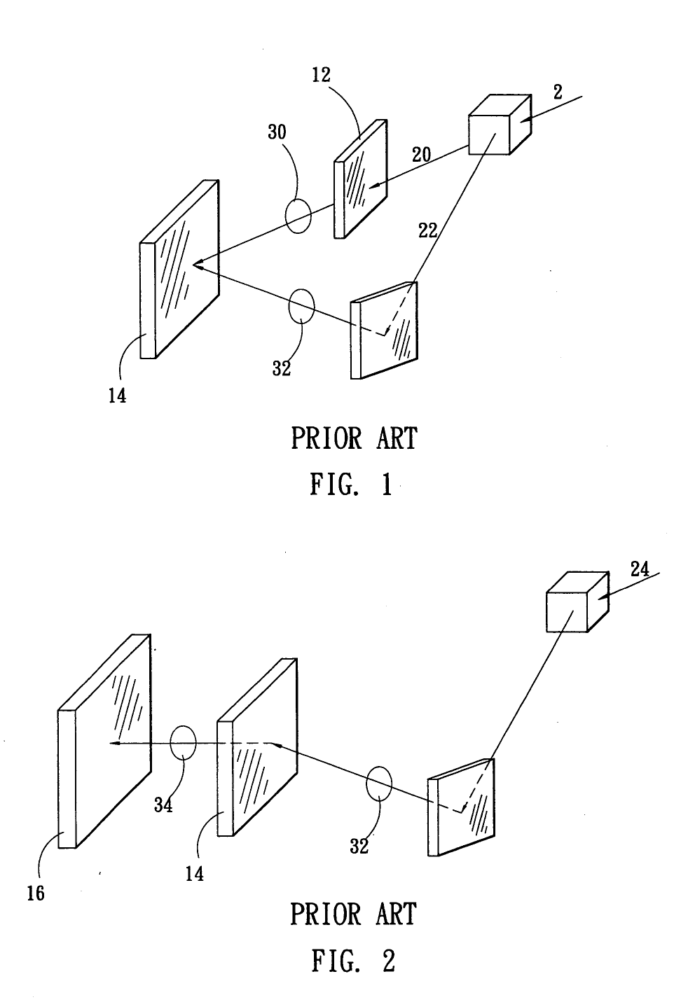

### DETAILED DESCRIPTION OF THE INVENTION

The present invention will be apparent from the following detailed description, which proceeds with reference to the accompanying drawing, wherein the same references relate to the same elements.

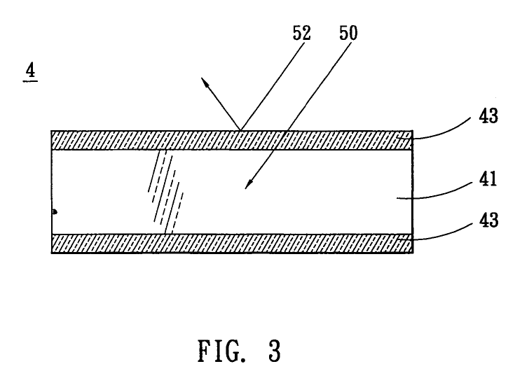

With reference to FIG. 3, a holographic data storage medium 4 according to a preferred embodiment of the invention includes a data storage body 41 and a protective layer 43.

The data storage body 41 is used to record a holographic data, which is a three-dimensional image data. In the embodiment, the data storage body 41 is consisting of a photosensitive polymeric material. In details, a photoactive monomer and a photoinitiator are mixed, and then are solidified to obtain the data storage body 41. The data storage body 41 is, for example, the conventional data storage medium 14 as mentioned above.

The protective layer 43 is disposed on the surface of the data storage body 41, and only light 50 of a specific wavelength is allowed to pass through the protective layer 41. In the current embodiment, the data storage body 41 is disc-like, and the protective layer 43 is formed on two opposite sides, the upper and the lower sides, of the data storage body 41. The protective layer 43 can be composed of inorganic materials such as TiO₂—Fe₂O₃, or organic materials such as benzene polyester. Furthermore, the protective layer 43 can also encapsulate the whole surfaces of the data storage body 41. For example, the shape of the data storage body may be cubic, and the protective layer is formed on the six square surfaces of the data storage body to encapsulate the entire data storage body (not shown).

In this embodiment, the protective layer 43 is an anti-UV protective layer. In other words, the specific-wavelength light 50 that can pass through the protective layer 43 is not UV light, and the light 52, which cannot pass through the protective layer 43, is UV light. Thus, the data storage body 41 can be prevented from being directly irradiated by UV light.

In an additional embodiment of the invention, the specific-wavelength light 50 is blue light with a wavelength between 400 nm and 500 nm. In a further embodiment of the invention, the specific-wavelength light 50 is red light with a wavelength between 600 nm and 700 nm. In the embodiments, the protective layer 43 allows the specific-wavelength light 50, such as the blue light or red light typically used in the conventional optical recording technology, passing through itself, so that the typical blue or red light laser beam can be employed to write into or read from the data storage body 41. Furthermore, since the wavelength of UV light is smaller than 320 nm, the protective layer 43 of course can filter the UV light. Therefore, the purpose of the embodiment to prevent the data storage body 41 from Uv light can be achieved.

It should be noted that the light of specific wavelength could be light with any wavelength except the UV light and could pass through the protective layer. Moreover, the data storage body can be disposed with a plurality of protective layers to achieve the purpose of allowing the light of specific wavelength to pass through the protective layers and stopping the UV light.

In summary, since the holographic data storage medium of the invention has a protective layer to filter away UV light, the photosensitive data storage body of the holographic data storage medium can be protected well. Accordingly, the data recorded in the data storage body can be protected from damage caused by UV light.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A holographic data storage medium, comprising:
a data storage body, which is used to record holographic data; and
a protective layer, which is disposed on the surface of the data storage body, wherein only light of a specific wavelength is allowed to pass through the protective layer.

2. The holographic data storage medium of claim 1, wherein the holographic data are three-dimensional image data.

3. The holographic data storage medium of claim 1, wherein the data storage body is consisting of a photosensitive polymeric material.

4. The holographic data storage medium of claim 1, wherein the data storage body is consisting of a photoactive monomer and a photoinitiator.

5. The holographic data storage medium of claim 1, wherein the protective layer encapsulates the data storage body.

6. The holographic data storage medium of claim 1, wherein the protective layer is an anti-UV protective layer to prevent the data storage body from UV light.

7. The holographic data storage medium of claim 1, wherein the light of the specific wavelength is blue light.

8. The holographic data storage medium of claim 7, wherein the specific wavelength is between 400 nm and 500 nm.

9. The holographic data storage medium of claim 1, wherein the light of the specific wavelength is red light.

10. The holographic data storage medium of claim 9, wherein the specific wavelength is between 600 nm and 700 nm.
